(19) United States
(12) Patent Application Publication
(10) Pub. No.: US 2004/0225632 A1
(43) Pub. Date: Nov. 11, 2004

(54) Automated information management and related methods

(75) Inventors: Max L. Benson, Redmond, WA (US); Stephen Siu, Vancouver (CA); James H. Booth, Barrie (CA)

Correspondence Address: LEE & HAYES PLLC, 421 W RIVERSIDE AVENUE SUITE 500, SPOKANE, WA, 99201

(73) Assignee: MICROSOFT CORPORATION, REDMON, WA (US)

(21) Appl. No.: 10/434,411

(22) Filed: May 8, 2003

(51) Int. Cl. G06F 7/00; G06F 17/30; G06F 17/60

(52) U.S. Cl. 707/1

(57) ABSTRACT

Subject matter includes automation of information management through a user-controllable series of runs. In one implementation the series of runs may be gathered into a run profile that has arranged steps for an agent to execute the information management process. The user-controllable series of runs, or run profile, allows performance of many information management processes by the same agent without reconfiguring the agent.

### CROSS-REFERENCE TO RELATED APPLICATIONS

The instant application is related to co-pending U.S. Patent Application Ser. No.______, Applicant Docket No. MS1-1532, entitled “Attribute Value Selection for Entity Objects,” by Kim Cameron, Max L. Benson, Matthias Leibmann, Edward H. Wayt, Kevin Miller and James Booth; U.S. Patent Application Ser. No.______, Applicant Docket No. MS1-1535, entitled “Declarative Rules for Metadirectory,” by Kim Cameron, Max L. Benson, and James Booth; U.S. Patent Application Ser. No.______, Applicant Docket No. MS1-1576 entitled “Relational Directory,” by Kim Cameron, James Booth, Matthias Leibmann, Max L. Benson and Mark Brown; U.S. Patent Application Ser. No.______, Applicant Docket No. MS1-1534, entitled “Associating and Using Information in a Metadirectory,” by Max L. Benson; U.S. Patent Application Ser. No.______, Applicant Docket No. MS1-1533, entitled “Preview Mode,” by Kim Cameron, Max L. Benson, Derek Murman, Edward H. Wayt, Jeffrey Bisset, Jie Liu, and Jing Wu; U.S. Patent Application Ser. No. ______, Applicant Docket No. MS1-1554, entitled “Rules Customization and Related Methods,” by Max L. Benson, Michael Jerger, Edward H. Wayt, Kenneth Mark, Kim Cameron, Matthias Leibmann, and Jing Wu; all of which are filed concurrently herewith, assigned to the assignee of the present invention, and incorporated herein by reference for all that they teach and disclose.

### TECHNICAL FIELD

The subject matter relates generally to database connectivity and more specifically to automated information management and related methods.

### BACKGROUND

A computing system user or an administrator often desires to synchronize information between databases or unify information from heterogeneous information sources into a single harmonized “record” of preferred information in a preferred format that can then be used as the “best” information or to exert administrative control over the separate databases and information sources. A metadirectory, for instance, can be a key directory that provides an overarching view of multiple directories and may be able to consolidate information in multiple directories, manage relationships between the directories, and allow data to flow between these connected directories.

A metadirectory system, or any mechanism for synchronizing diverse information sources, is beneficial because an average company has many accounts, storage repositories, directories, and systems that include information about people, computers, and network entities. Often, such sources of information are not necessarily designed to work together or to achieve consistency or harmony of information. For example, a company's computer network settings, printer settings, telephone system configuration, and quality of service policy may be redundantly spread across client computers, servers, network devices, and directory services. Network security policy may reside in both network devices and firewall services. A company's management profile, company policy, and personnel database may be spread across different directories on different servers. Employee information may reside partly on email servers that have mailbox and address information, and partly in other various accounts and departments, such as recruiting, payroll, employee benefits, production scheduling, and performance evaluation. Information spread across these various repositories is typically uncoordinated and/or redundant. Further, since each account or system typically uses a slightly different storage format, the information is also apt to be inconsistent and incomplete when compared to a hypothetical complete and accurate record of identifying information (e.g., “identity information”) about a person or entity.

A metadirectory or a synchronized set of databases provides a “central control center” that presents a unified view of information that may be spread across diverse information sources in different locations. In the case of a metadirectory, user or administrator can select which identity information, attributes, and values are to compose the unified identity information and then disseminate selected attributes and values to the diverse information sources in different locations without having to export to each information source individually.

Still, although a metadirectory can pull together very diverse types of identity information, much work may be needed to configure agents and services in a metadirectory to keep numerous information sources that are connected to the metadirectory maintained and updated, not to mention the maintenance and upkeep of the metadirectory itself. A metadirectory system belonging to an international corporation may perform a full export and import cycle with computing domains in Asia and Europe, for example, each having unique connection protocols, on Tuesday and Friday nights but performs only a partial import cycle (a “delta add” of only that information which has changed since the last import) on Wednesday nights. On these same processing days (Tuesday, Wednesday, Friday) the same metadirectory system performs various imports and exports in the United States using a different connection protocol. Adding to potential complexity, the aforementioned imports and exports are only between a tentative staging buffer of the metadirectory system and the connected domains in Asia, Europe, and the United States. Once a week, on Thursdays, the metadirectory system synchronizes itself, that is, it harmonizes selected information that was staged in its buffer during the Asia, Europe, and U.S. cycles with the unified identity information that comprises its unified view of the diversely located information. Then the metadirectory system exports changes to the various international domains.

In the case synchronization between two or more databases, the user may be presented with many different “modes” of synchronization, wherein a full mode synchronizes everything in one database to another, a partial or “delta” synchronization accords only those pieces of information that have changed since the last synchronization session, and synchronization with a laptop computer may differ than synchronization with a backup volume stored on a storage area network.

The agents, engines, services etc. managing synchronization of information between databases or within a metadirectory system typically need to be reconfigured for each of their different activities or “modes” described in the examples above. A mechanism is needed to avoid reconfiguring these agents, engines, and services each time a different mode of synchronization is performed, or performed between different databases or information sources.

### SUMMARY

Subject matter includes automation of information management through a user-controllable series of runs. In one implementation the series of runs may be gathered into a run profile that has arranged steps for an agent to execute the information management process. The user-controllable series of runs, or run profile, allows performance of many information management processes by the same agent without reconfiguring the agent.

### BRIEF DESCRIPTION OF THE DRAWINGS

FIG. 1 is a graphic representation of an exemplary metadirectory including having exemplary run profiles.

FIG. 2 is a block diagram of one implementation of the exemplary metadirectory including an exemplary run profile.

FIG. 3 is a block diagram of an exemplary identity information management process.

FIG. 4 is a block diagram of an exemplary identity information management engine.

FIG. 5 is a flow diagram of an exemplary method of automating a metadirectory.

FIG. 6 is a flow diagram of another exemplary identity information management process.

FIG. 7 is a block diagram of an exemplary computing device suitable for use with the subject matter.

### DETAILED DESCRIPTION

Overview

The subject matter described herein includes automation of information management, particularly automation of the services, engines, agents, that carry out the information management but conventionally must be reconfigured for various modes of management. The subject matter can thus decrease or eliminate the need to reconfigure services, engines, agents, etc. during database synchronization or management of a metadirectory.

In one implementation, the subject matter is a series of user-controllable runs for synchronizing information between databases. In one implementation, the subject matter is a recipe, program, map, sequence of operations, etc., which will be referred to herein as a “run profile” that the various agents, engines, and services of a metadirectory follow to accomplish parts of larger tasks that they are usually not capable of performing individually and/or without guidance, or, without being reconfigured. A typical agent, for example, a management agent (MA) that performs processes between a metadirectory and a single information source connected to the metadirectory, usually performs only one segment of a more global process, and usually in only one data flow direction. A unidirectional MA may need to be reconfigured to change data flow direction, connection parameters, etc. The various tasks that an MA can perform, or more accurately, the various ways an MA can be used (usually by being reconfigured) will be referred to herein as “execution modes” or “modes.”

In one implementation, an exemplary run profile allows an MA to be programmed to execute in a sequence of different modes without having to reconfigure the MA. Each run profile can be independent from other run profiles, and in some implementations can be easily developed via scripts, and subsequently accessed and run by an administrator. Hence, as a feature of a metadirectory, an exemplary run profile allows for greater automation, simplicity and flexibility when connecting and transferring information between disparate information sources and the metadirectory, and when synchronizing information within a metadirectory.

In one implementation, a user-controllable series of runs allows a database synchronization system to synchronize, for example, a multitable database. The series of run can be implemented in rearranageable steps, each step associated with a corresponding mode of a synchronization process. The various steps of the user-controllable series of runs, for example, might be available to the user via a checklist on a user interface, or might be configurable and then storable by the user, so that the user can reuse and rearrange the preconfigured run steps.

In one implementation, an exemplary run profile can include a step to create a “drop file” of information being transferred or maintain an audit trail, audit file, or other record of execution modes and tasks accomplished.

In one implementation, a metadirectory or database system can automatically generate a run profile or an automated series of runs. A record of system interactions during a real-time information management process or during database synchronization using a user controllable series of runs can be converted or assembled into run profile code. In other words, the system remembers how a management process or database synchronization was performed and replays at least some aspects of the former run(s). The automatically generated run profile may be generated at least in part from an audit trail or other tracking mechanism that creates an artifact of system activity as it occurs.

In one implementation, a metadirectory or a database system creates a master run profile to control other run profiles. A master run profile, like non-master run profiles, can be created automatically when a system remembers the execution of a series of run profiles, and writes an executable list or program incorporating the series.

One use for an exemplary run profile is to separate the configuration information that controls the execution of an agent or service from the agent or service itself. This allows a user or administrator to configure multiple run profiles that allow, e.g., an MA, to be executed in a variety of modes without having to be manually reconfigured for each mode. This is especially useful in automated infrastructure environments.

Exemplary Metadirectory

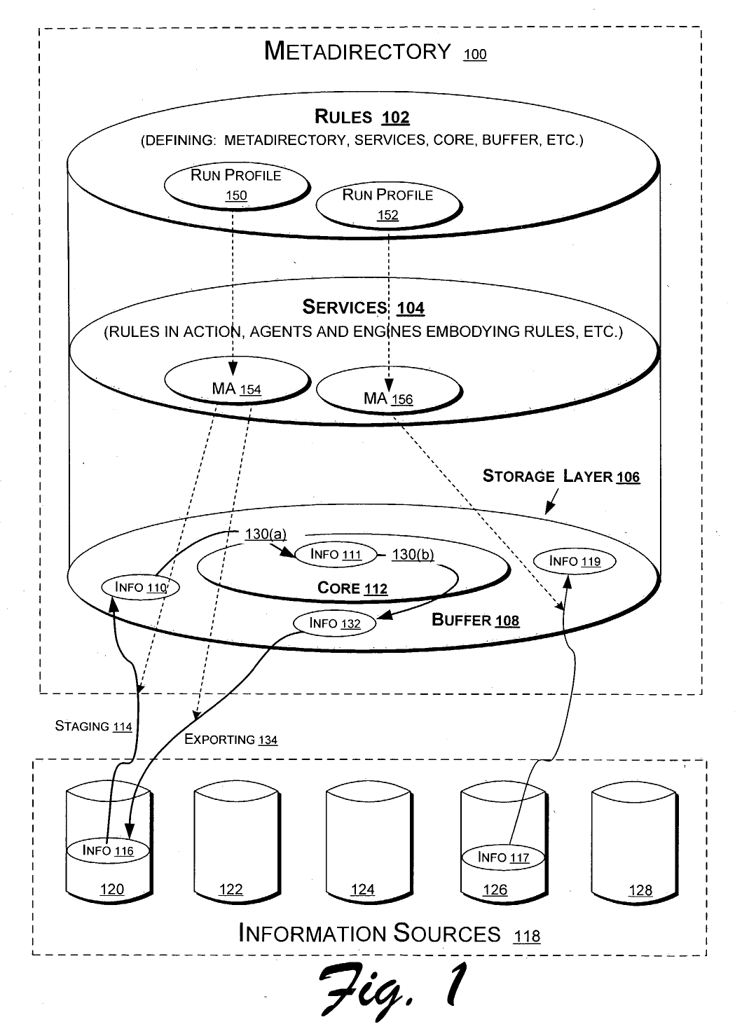

As shown in FIG. 1, an exemplary metadirectory 100 according to the subject matter can be understood in terms of various layers. An exemplary rules layer 102 provides rules (schemata, specifications, definitions, etc.) including exemplary run profiles 150, 152 for implementing the exemplary metadirectory 100. These rules may drive, implement, or be actualized in various actions, agents, engines, and/or objects of other exemplary layers, such as an exemplary services layer 104 for performing actions (e.g., information management) and an exemplary storage layer 106 for holding information. In one implementation, the storage layer 106 has a buffer storage space (“buffer”) 108, which serves as an intermediate staging space for “buffer information” 110 going to or coming from a core storage space (“core”) 112. The buffer 108 may have its buffer information 110, 132 imported in a process known as “staging” 114 from connected information 116 stored in one of multiple disparate information sources 118 (e.g., one of 120, 122 124, 126, 128), such as a remote database, a directory, a MICROSOFT® ACTIVE DIRECTORY type of directory, an SQL type database, a lightweight directory access protocol (LDAP) directory, a file, another metadirectory system, and other proprietary database and email address repositories. The core 112 stores or persists information known as “unified identity information” 111 that is taken (i.e., preferred, selected, filtered, unified, integrated, etc.) from the buffer information 110 in the buffer 108 according to rules in the rules layer 102 in a process called “synchronizing” 130(a), 130(b). A piece or object of unified identity information 111 provides a persistent view or representation of information that may be stored in many different forms and many different stages of completeness in the connected information sources 118.

Synchronizing 130 between the core 112 and the buffer 108 can be “inbound” 130(a) to the core 112 or “outbound” 130(b) from the core 112. Thus, the unified identity information 111 in the core 112 is taken or derived only indirectly from the multiple disparate information sources 118 since the buffer 108 intervenes. In synchronizing 130, a service performs (inbound) data aggregating by updating a piece of unified identity information 111 in the core 112 based on buffer information 110 staged in the buffer 108 or, the same or another service performs (outbound) account managing by updating a piece of buffer information 132 in the buffer 108 based on a piece of unified identity information 111 in the core 112. Appropriate information from the updated buffer information 132 gets exported to an appropriate information source (e.g., one of 120, 122, 124, 126, 128).

For exporting 134, the user may select an attribute or Value viewed in a piece of unified identity information 111 to be applied to all connected information sources 118. A staged object (e.g., the buffer information 132) may be used to reflect the attribute or value to be exported. The attribute or value may then be exported to each connected information source 118.

Thus, once unified and/or integrated, the unified identity information 111 achieved in the core 112 may be used to administer the information sources 118. Through (outbound) synchronizing 130(b), changes to the unified identity information 111 in the core 112 can be provisioned in the buffer information 132. Through exporting 134, the buffer information 132 can be disseminated in order to change, augment, or replace connected information 116 in one or more of the information sources 118.

Within this basic exemplary metadirectory 110 structure and function just described, a number of exemplary run profiles 150, 152 may automate or help to automate the exemplary metadirectory 100, especially the actions performed by the services layer 104. In a typical scenario, an exemplary run profile 150 may cause an MA 154 to perform exporting 134 to a connected information source 120 and then, without reconfiguring the MA 154, cause the MA 154 to perform staging 114 back to the exemplary metadirectory 100 to check the correctness of information received. This is a basic example of how a run profile 150, 152 allows a service or agent to function in multiple modes in an automatic sequence. Another exemplary run profile 152 may allow another MA 156 to automatically stage incoming information 117 as buffer information 119, e.g., a “connector object,” in the buffer 108.

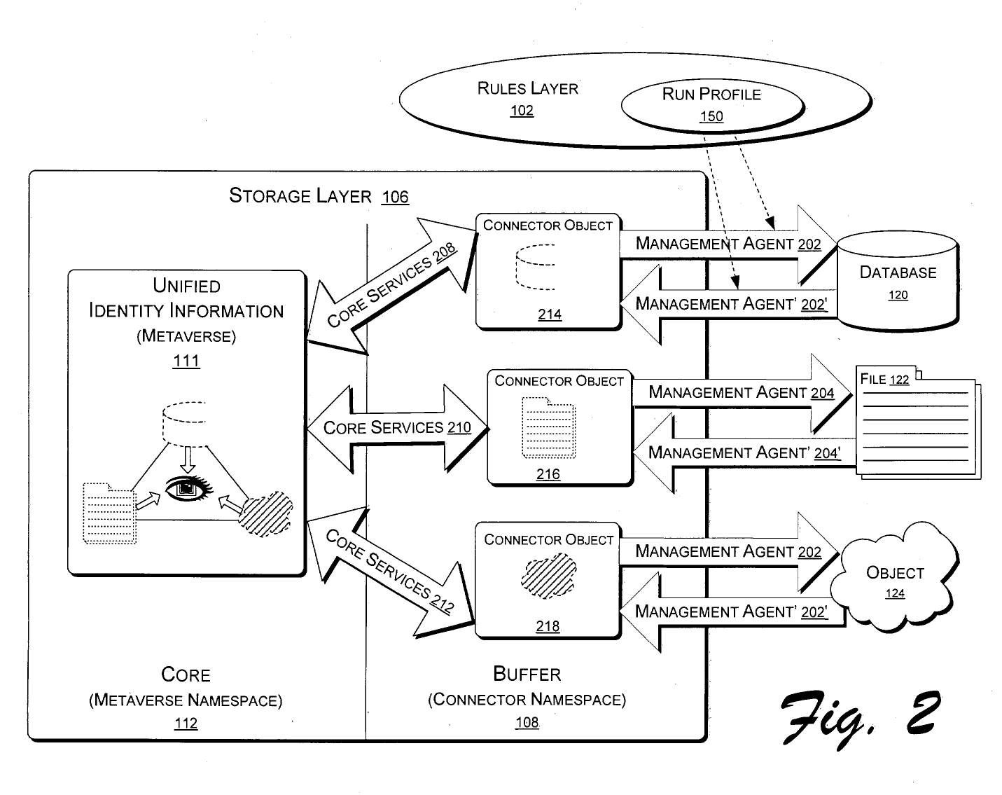

FIG. 2 shows the exemplary rules layer 102 and the exemplary storage layer 106 (of FIG. 1) as implemented in MICROSOFT® METADIRECTORY SERVICES metadirectory products and MICROSOFT® IDENTITY INTEGRATION SERVER (“MIIS”) products, providing an example environment for practicing the subject matter (Microsoft Corporation, Redmond, Wash.).

In an MIIS context, the buffer 108 can be implemented as an MIIS connector namespace, and the core 112 can be implemented as an MIIS metaverse namespace, wherein a metaverse is one or more pieces or objects of the unified identity information 111. The buffer 108 allows object staging, which in turn allows unified identity information 111 in the core 112 to be composed of selected objects and attributes of buffer information 110 called connector objects 214, 216, 218. The unified identity information 111 allows maintenance integrated information from multiple connected information sources 118 while being able to adapt to the unique characteristics of each individual connected information source (e.g., 120, 122, 124, 126, 128).

The buffer information 110, 132 can include many types of information, only a part of which becomes unified identity information 111 in the core 112. For example, a piece of buffer information 110 can be present for metadirectory housekeeping and not connected to the core 112 at all. At least some of the buffer information 110, 132 can consist of a representation, (e.g., a MIIS connector object or a shadow, data image, template, view, etc.) of selected information residing in (or from the perspective of) a connected information source (e.g., one of 120, 122, 124, 126, 128). Accordingly, an MA 202, 204, 206 can use such a representation or object in the buffer 108 to stage information between the connected information source 120 and the unified identity information 111. For example, an MA 202 may execute business logic or a custom template that imports changed information (e.g., a “delta” object containing changed attributes or values) via a connector object 214 from a previously imported state of the connected information source 120.

In instances where buffer information 110, 132 is not joined to unified identity information 111 the buffer information 110, 132 may be referred to as disconnected information (i.e., a disconnector object). Whereas a connector object represents an object imported from a connected information source (one of 120, 122, 124, 126, 128) that has been joined to a piece of unified identity information 111, a disconnector object represents an object that is not joined to unified identity information 111. Disconnector objects are typically used to represent functional accounts, administrator IDs, etc., which do not always correspond to a piece of unified identity information 111.

Thus, a staged object in the buffer 108 is automatically a disconnector object upon creation from a new connected information source (e.g., one of 120, 122, 124, 126, 128), but becomes redefined as a connector object when joined to or projected as unified identity information 111. A staged object in the buffer 108 created for export is automatically a connector object if it already has some link to unified identity information 111.

The services layer 104 can use or embody objects known as agents or management agents (MAs) 202, 204, 206 to cause information to flow and/or otherwise be manipulated. For example, an MA' 202′ can discover the contents of a connected information source 120 and then place object entries from the connected information source 120 into a connector object 214 in the buffer 108 (e.g., the MIIS connector namespace). Another agent or service, such as a core service 208, can then place an appropriate object from the connector object 214 in the buffer 108 into the core 112 (e.g., the MIIS metaverse namespace). Further, another or the same core service 208 may cause mapping of at least some information (e.g., data, attributes, etc.) from an object in the core 112 to a connector object 214 in the buffer 108. In the latter instance, yet another or the original MA 202 may yet again cause mapping of at least some information from the connector object 214 in the buffer 108 to the connected information source 120.

An exemplary metadirectory 100 consists of agents or services that can connect objects, and specifically in the case of MIIS, the MAs 202, 204, 206 each communicate between the exemplary metadirectory 100 and one of the connected information sources (e.g., one of 120, 122, 124, 126, 128). Each MA 202 may contain several classes of configuration data that allow it to connect and communicate with its associated information source 120.

“Connection configuration” is a class of configuration data that describes how the MA 202 should connect to the information source 120 and what credentials to use for the connection.

“Schema configuration” is a class of configuration data that describes how the exemplary metadirectory 100 should interpret the schema (layout, configuration, etc.) of the connected information source 120. This allows the MA 202 to understand how to comprehend objects and attributes in the connected information source 120.

“Synchronization rules” is a class of configuration data that describes how the exemplary metadirectory 100 should synchronize objects and attributes between different connected information sources 118, i.e., with each other and with the unified identity information 111, or metaverse.

“Execution configuration” is a class of configuration data that describes in what “mode” the management agent should run in. For example, an import mode stages information 116 from the connected information source 120 to the buffer 108 and an export mode distributes outbound changes from the buffer 108 out to the connected information source 120. There are additional modes, of course, as mentioned above, and options that can be configured for each. These will be described below.

In order to change the execution mode of an MA 202 (i.e., without using an exemplary run profile 150), the aforementioned execution configuration of the MA 202 has to be altered and committed to a server. This manual alteration of the execution configuration makes difficult the automatic use of an MA 202 in different environments and in different modes. For example, it may be desirable to run the MA 202 in “delta mode” on certain days and “full mode” on others.

Separately from an MA 202, a user or administrator can create an exemplary run profile 150, a programmatic sequence of execution steps, that describes the manner(s) in which the MA 202 should be executed. Each exemplary run profile 150, 152 is independent of others and does not require any change to the other classes of configuration information, described above, that are associated with the MA 202. The user or administrator can then manually run an exemplary run profile 150 or create a means for running the profile, such as a program, macro, etc., Or a script that runs an exemplary run profile 150 with WINDOWS® MANAGEMENT INSTRUMENTATION (WMI).

With an exemplary run profile 150, rather than manually reconfiguring the MA 202 when a process demands a different run mode, a user or administrator can just access a different exemplary run profile 150 using a script. Furthermore, each exemplary run profile 150, 152 contains multiple “steps” that allow the user or administrator to execute the MA 202 in a sequence of different modes.

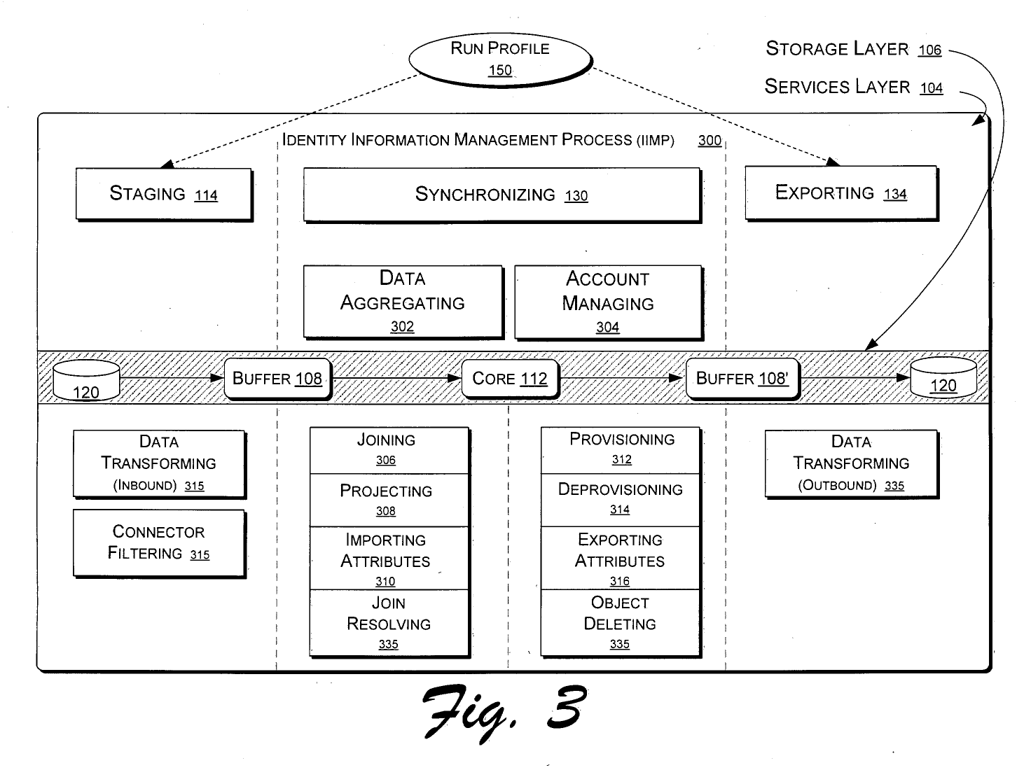

FIG. 3 shows an exemplary “identity information management process” (IIMP) 300 that can be automated using a number of exemplary run profiles 150, 152.

The exemplary IIMP 300 includes the staging 114, synchronizing 130(a), 130(b), and exporting 134 described above, and when viewed with respect to unified identity information 111 stored in a core 112, then added levels of processing may be introduced that aim to provide functionality and ensure data integrity across more than one connected information source (e.g., 120, 122, 124, 126, 128). Such additional processes include, for example, data aggregating 302 inbound information 110 and account managing 304 outbound buffer information 132. Further, such additional processes may have sub-processes. For example, data aggregating 302 may include joining 306, projecting 308, and importing of attributes 310. Joining 306, for example, is the process of relating parts of the unified identity information 111 to each other. Projecting 308 is the process of creating unified identity information 111 to represent buffer information 110. Account managing 304 may include provisioning 312, deprovisioning 314, and exporting attributes 316. Provisioning 312 may be described as building new relationships between parts of new unified identity information 111 and connector objects 214, 216, 218 so that the changes and new relationships can affect the connected information sources 118. Deprovisioning 314 may be described as modifying or deleting one or more connector objects 214, 216, 218 when they are to be unlinked from unified identity information 111, for instance, upon it pending deletion. In general, such processes and/or sub-processes may be controlled by any of a variety of MAs 202, 204, 206 executing in various modes and other services that ensure the most valued, most correct, and/or user-selected unified identity information 111 resides in the core 112 and in one or more connected information sources 118, as appropriate.

In some implementations of the exemplary metadirectory 100, such as the MIIS 2003 implementation, the processes in the exemplary IIMP 300 can be executed in a relatively well-defined sequence, that is to say, the various parts of the exemplary IIMP 300 are not usually performed independently and not performed at random or haphazardly.

The various connected information sources 118 are usually heterogeneous in their connection requirements, their schemata, and their location, etc. Thus, an exemplary run profile 150 may be especially useful in automating the information transfers that take place between the metadirectory's buffer 108 and multiple connected information sources 118. As mentioned with regard to FIG. 1, these information transfers are referred to as staging 114 (“importing” may also be used) for inbound information coming from the connected information source 120 to the buffer 108, and exporting 134 for outbound information being transferred from the buffer 108 to the connected information source 120. In one implementation, staging 114 and exporting 134 are reserved for MAs, such as MAs 202, 204, 206.

Exemplary IIMP Engine

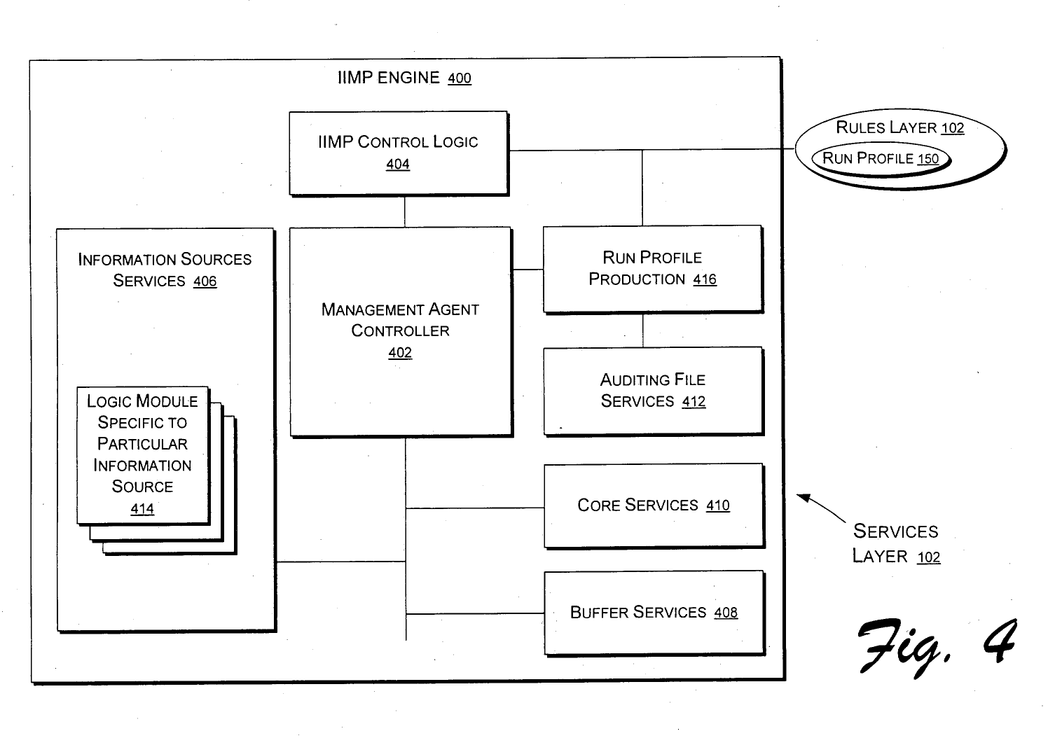

FIG. 4 shows an exemplary IIMP engine 400 for implementing the exemplary IIMP 400 and executing exemplary run profiles 150, 152. As mentioned, applying business logic to the various heterogeneous connected information sources 118 is a complex task that may be automated and made more flexible by using an exemplary run profile 150.

The exemplary IIMP engine 400 can include an MA controller 402, an IIMP control logic component 404, an information sources services component 406, a buffer services component 408, and a core services component 410 communicatively coupled as illustrated. The exemplary IIMP engine 400 may also include an auditing file services component 412. An optional run profile production component 416 may also be included in some implementations. The information sources services component 406 includes a logic module 414 for each of the connected information sources 118.

In this implementation, the MA controller 402 is initiated to execute a run profile 150. Each run profile 150 includes execution steps to be executed by an MA 202, and each execution step may have subtypes. An execution step, as will be described in more detail below, defines each type of step and/or each subtype of each type of step in a run profile 150. Certain “step types” are defined that correspond to MA modes described above. A step type, i.e., a mode that an MA 202 executes in, may have multiple subtypes, i.e., multiple configuration options available.

The MA controller 402 analyzes a run profile 150 and executes each step to completion (all objects to be processed for one step are processed before moving to a next step). In an individual step, the MA controller 402 initializes components for reading and writing objects for that step, to keep the information management process 300 moving.

If the step being executed by the MA controller 402 involves importing or exporting information to and/or from a connected information source 120, the MA controller 402 initializes a logic module 414 specific to a particular information source 120 for reading objects. The component written to varies: if the step being executed by the MA controller 402 involves staging 114, the MA controller 402 initializes a buffer services component 408 to stage, for example, deltas to objects in the buffer 108. If changes are being applied to unified identity information 111, the MA controller 402 initializes a core services component 410 to write changes to the core 112 and also a buffer services component 408 to stage export deltas in the buffer 108. If the step involves importing information to a file, the MA controller 402 may initialize an auditing file services component 412 to write drop file.

If reading from a drop file (i.e., import from file), the MA controller 402 may initialize an auditing file services component 412 for reading information and for writing, a buffer services component 408 can be initialized if staging deltas to objects in the buffer 108 or, if applying changes to unified identity information 111 in the core 112, a core services component 410 can be initialized as well as a buffer services component 408 to stage export deltas in the buffer 108.

If applying changes to unified identity information 111 in the core 112, the MA controller 402 can initialize a buffer services component 408 for reading information and a core services component 410 and a buffer services component 408 for writing.

If exporting information to a connected information source 120, the MA controller 402 may initialize a buffer services component 408 for reading and if exporting to file, then the MA controller 402 may initialize an auditing file services component 412 for writing. But if exporting to a connected information source 120 then the MA controller 402 may initialize a logic module 414 specific to a connected information source 120 for writing.

For all of the above, if auditing is selected, the MA controller 402 may also initialize an auditing file services component 412 to write the audit file. That is, in one implementation the auditing file services component 412 produces an audit trail and/or file that describes interactions between information being processed and the information management process acting on the information.

An optional run profile production component 416 may produce an exemplary run profile 150 using information output or stored in a file by an auditing file services component 412. In one implementation the auditing file services component 412 writes output in a form that can later be used as or converted into executable instructions such as the steps of an exemplary run profile 150, e.g., an audit file content stored in XML that can be converted to a replay of at least some of the exemplary IIMP 400.

First Exemplary Run Profile XML Structure

An exemplary run profile 150 suitable for controlling MAs in the IIMP engine 400 described above can be implemented in many types of data structures and rendered using different programming languages. Since an exemplary run profile 150 is metadata for execution of an MA 202, a meta-language may be especially suitable for creating and using an exemplary run profile 150. Examples included herein are shown in extensible markup language (XML) as representative of other markup languages and meta-languages that could be used.

In one implementation, some elements of an MA's 202 configuration are stored as an XML file in a server while other elements are normalized, for example, into SQL columns in a database of a connected information source 120. It should be noted that an XML representation may exist wholly or in part only as an intermediate form for interchange purposes.

Each exemplary run profile 150, then, can be contained as a portion of the MA's configuration file. One example code listing showing structure of an exemplary XML run profile 150 is as follows (line numbers added):

```
<run-configuration>
  <id> <id>
  <name> </name>
  <creation-time> </creation-time>
  <version> </version>
  <last-modification-time> </last-modification-time>
  <configuration>
      <step>
          <step-type type=“full-import”>
              <import-subtype> </import-subtype>
              .
              .
          </step-type>
          <dropfile-name> </dropfile-name>
          <threshold />
          <partition> </partition>
          <custom-data>
                .
                .
          </custom-data>
      </step>
      .
      .
      .
  </configuration>
</run-configuration>
```

In the “steps” element(s) (lines 008-021), the example XML structure above specifies a sequence of steps for an MA 202 to perform. Steps may be of a “step-type,” in this case the step-type is a “full import” as shown at line -009. The step-type may allow further qualifying information, such as a step subtype (at line 010). There is also capacity in the XML structure to designate a filepath name for a drop file (line 014). Thresholds may be set (line 015), partitions designated (line 016), and custom data added (line 017).

Overview of Exemplary Execution Step Instructions

Each execution step in an exemplary run profile 150, such as a run profile 150 rendered as an XML structure, may be of a certain “type.” An execution step instruction, as described above with respect to FIG. 4, explains or defines each type of step and/or each subtype of each type of step. In one implementation, certain “step types” are defined that correspond to MA modes described above. A step type, i.e., a mode that an MA 202 executes in, may have multiple subtypes, i.e., multiple configuration options available.

There are several exemplary step types corresponding to the aforementioned exemplary execution modes. A “full import” step type directs the MA 202 to connect to an information source 120 and retrieve all information or objects within the scope of the connection and stage this information in the buffer 108 or synchronize this information in the core 112.

A “delta import” step type directs the MA to connect to an information source 120 and retrieve only that information or those objects that have changed since the last communication and stage this information in the buffer 108 or synchronize this information in the core 112. Not every type of connected information source (120, 122, 124, 126, 128) can support this step type.

Another step type does not involve communication with a connected information source 120 but pertains to synchronizing 130(a), 130(b) within a buffer 108. A “synchronize only” step type directs an MA to synchronize its staged information 110, e.g., its connector object(s) 214, with unified identity information 111 in the core 112 and possibly with staged information, e.g., connector objects (216, 218), of other MAs. The “synchronize only” step type can actually be two step types, a full synchronize only step type and a delta synchronize only step type. Delta synchronizing only processes objects and attributes that have changed since a last synchronization. Full synchronizing processes all objects and attributes regardless if they have changed since the last synchronization.

An “export” step type directs the MA to connect to an information source 120 and transfer changes made in the synchronizing step types back to the relevant connected information source 120.

Overview of Exemplary Step Subtypes

In one exemplary step subtype, for any given step in an exemplary run profile 150, there can be a number of optional configuration settings that allow a user or administrator to create log files used, e.g., for auditing. In addition, an exemplary IIMP 300 can be facilitated by an exemplary run profile 150 to specify not only the MA's step type, or mode, but also points in the IIMP 300 at which the execution of the MA 202 can be stopped for user examination, debugging, etc . . .

In another step subtype, a user or administrator can configure an exemplary run profile 150 to select how many objects the MA 202 should process. For example, the user or administrator can select that either a specific number of objects or all available objects be processed during execution of a staging 114 or an exporting.

Finally, an exemplary run profile 150 can contain “custom” information specific to an MA's type and the characteristics of an associated connected information source 120.

Second Exemplary Run Profile XML Structure

In one MIIS implementation of the subject matter, an exemplary MA 202 includes an execute function that accepts a metadata parameter. A computing server instantiates an MA execution by passing an exemplary XML run profile 150 (or fragment thereof) as a parameter to the MA's execute function. A second example code listing showing structure for an exemplary XML run profile 150 that can be used with such an MA 202 is now provided (line numbers added):

```
<ma-run-data>
  <run-configuration>
      <name> string </name>
          <id> guid </id>
          <version> integer </version>
          <configuration>
          <step>
              <step-type type=”full-import | delta-import |
          export | apply-rules”>
              <import-subtype> to-file </import-subtype>
              <import-subtype> resume-from-file </import-
          subtype>
              <import-subtype> to-buffer </import-subtype>
              <export-subtype> to-file </export-subtype>
              <export-subtype> resume-from-file </export-
          subtype>
              <apply-rules-subtype> apply-pending
              </apply-rules-subtype>
              <apply-rules-subtype> reevaluate-flow-
          connectors </apply-rules-subtype>
              <apply-rules-subtype> reevaluate-join-flow-
          all </apply-rules-subtype>
              </step-type>
              <dropfile-name> string </dropfile-name>
              <threshold>
                    <object> integer </object>
              </threshold>
              <partition> string </partition>
              <custom-data> XML fragment </custom-data>
          <step>
          <step>
          ...
          </step>
          ...
      </configuration>
  </run-configuration>
  <run-configuration>
      ...
  </run-configuration>
</ma-run-data>
```

In this exemplary MIIS implementation of an XML run profile structure, an XML name tag at line 003 displays a name for a particular exemplary run profile 150, another element at line 004 includes a unique identifier, such as a GUID assigned to a particular exemplary run profile 150, and yet another element at line 005 includes a version number (e.g., an integer) of the particular exemplary run profile 150. These identifiers may help a user or an exemplary IIMP engine 400 to find and use exemplary run profiles 150, 152.

In the step-type elements, e.g., at line 010, the “type” attribute specifies the types of steps available for executing an MA 202, the steps being used only one at a time. In this implementation, the step types cannot be combined or logically “OR'ed” together. In this implementation, there are four step-types (at lines 010-011): full import, delta import, export, and apply-rules.

Import Step Subtypes

Table 1 shows various step subtypes that may be used in an exemplary XML run profile 150 to implement an exemplary import step. The import step can be a full or delta import step. The XML structure context of some import step subtypes are shown in the XML structure above at lines 013-016.

TABLE 1

| Import Step Subtypes: | Description: |
|---|---|
| (None) | Information is transferred from |
| | information source, to buffer, to core. |
| “to file” | Creates a drop file without staging |
| | information in the buffer. |
| “resume from file” | Resumes import to core from a drop |
| | file. |
| “to file resume from file” | Creates an audit file and continues |
| | import to core without stopping. |
| “to buffer” | Stages information to the buffer and |
| | stops. |
| “resume from file to buffer” | Resumes import from a drop file, stages |
| | the information in the buffer, and stops. |
| “to file, resume from file, to | Creates an audit file during the import, |
| buffer” | stages information to the buffer, and |
| | stops. |

As suggested by Table 1, various exemplary step subtypes can direct an MA 202 to proceed through one or several of the various segments of an exemplary IIMP 300. Some step subtypes involve only a small segment of an information management “circuit” between the exemplary metadirectory 100 and a connected information source, while other step subtypes or combinations thereof direct an MA 202 through almost the entire information circuit.

Table 2 shows various exemplary export step subtypes that may be used to implement an export step in an exemplary XML run profile 150. Some of these export step subtypes are shown in the XML structure above at lines 018-020.

TABLE 2

| Export Step Subtypes: | Description: |
|---|---|
| (None) | Information is transferred from the |
| | buffer to the information source. |
| “to file” | Creates a drop file during export and |
| | stops. |
| “resume from file” | Resumes export from a drop file. |
| “to file resume from file” | Creates an audit file and continues |
| | import without stopping. |

Table 3 shows various exemplary “apply-rule” step subtypes that may be used to implement an apply-rule step in an exemplary XML run profile 150. Some of these apply-rule step subtypes are shown in the XML structure above at lines 022-027.

TABLE 3

| Apply-Rule Step Subtypes: | Description: |
|---|---|
| “apply pending” | Attempts to synchronize all connectors |
| | with staged pending imports and also |
| | attempts to join/project (and flow |
| | attributes) on all normal disconnectors |
| | even if they have failed to join during |
| | previous apply-pending runs. |
| “reevaluate-flow-connectors” | Attempts to reevaluate attribute flow for |
| | all connectors in the buffer associated |
| | with the MA being executed. |
| “reevaluate-join-flow-all” | Reevaluates join and attribute flow for |
| | all entries in the buffer (connector |
| | objects and disconnector objects). |
| | Explicit connectors/disconnectors will |
| | not be reevaluated (can only be changed |
| | using account joiner). |

The apply-rule subtypes shown in Table 3 allow an MA 202 to execute in a mode that evaluates the “joins” and attribute flows between buffer entities and can synchronize connectors.

A drop file name element in the exemplary XML run profile structure (line 031) allows a user or administrator to specify the name of a drop file, log file, audit file, etc . . . A mechanism may also be provided in an exemplary metadirectory 100 for finding audit type drop files among other files or for finding a particular audit file.

One or more threshold elements may also be used in an exemplary XML run profile structure (lines 033-035). A threshold can be used to qualify steps of each type, e.g., staging, synchronizing, exporting, etc . . . One typical threshold for many exemplary MAs is the number of objects to import from a connected information source 120. Other thresholds may include stopping a run after a certain number of deletions have been processed or a certain number of processing errors have occurred.

Partition elements may also be used in an exemplary XML run profile structure (line 037). Since the format of each data partition in a connected information source is MA-specific, each step in an exemplary run profile 150 operates in a particular data partition in the connected information source 120.

An exemplary XML run profile 150 may also contain a custom data section for MA-specific data for each particular step in the XML structure (line 038). Different MAs (e.g., 202, 204, 206) that perform the same step type on a different connected information source (e.g., 120, 122, 124) may vary considerably in their internal logic, the rules they embody, and the connectivity information they use to communicate with their respective connected information sources (120, 122, 124).

Exemplary Methods

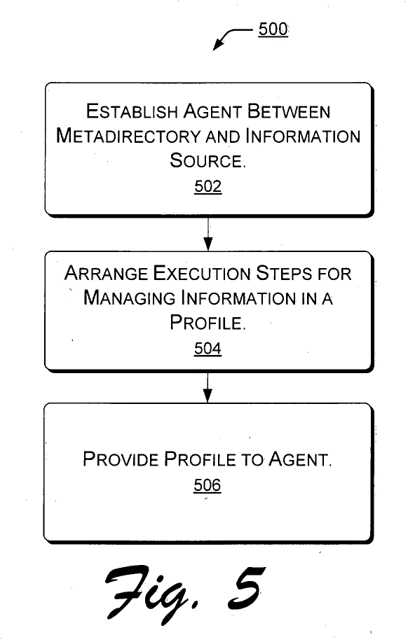

FIG. 5 shows an exemplary method 500 of automating an exemplary metadirectory 100 using an exemplary run profile 150. In the flow diagram, the operations are summarized in individual blocks. The operations may be performed in hardware and/or as machine-readable instructions (software or firmware) that can be executed by a processor or engine, such as the exemplary IIMP engine 400.

At block 502, an agent is established between an exemplary metadirectory 100 and an information source.

At block 504, execution steps for managing information in the exemplary metadirectory are arranged into a profile.

At block 506, the profile is provided to the agent.

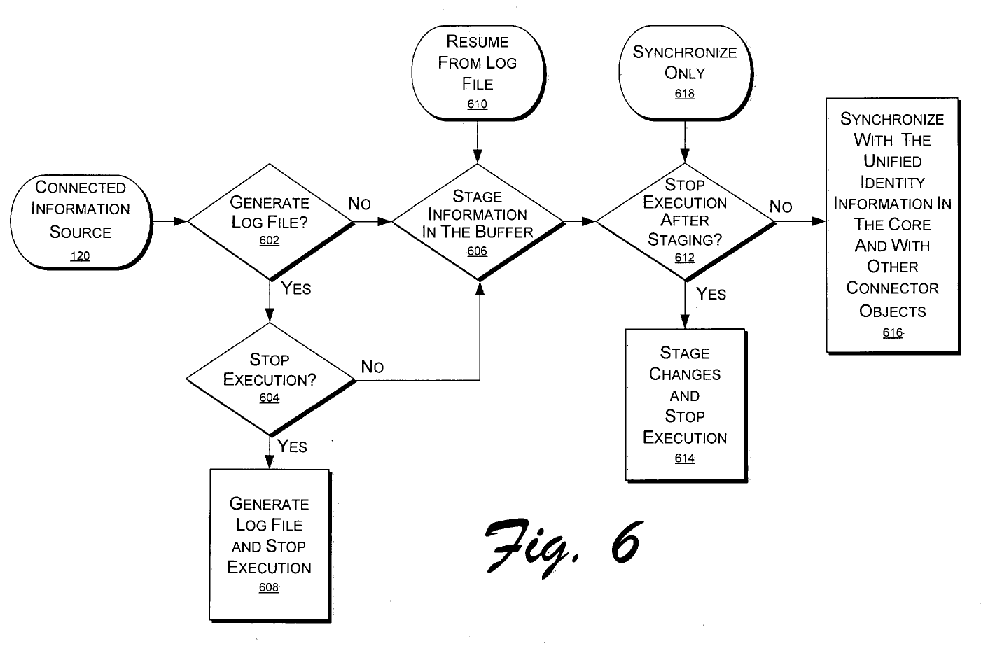

FIG. 6 shows another exemplary identity information management process (IIMP) 600 comprising a synthesis of the steps and subtypes just described above to offer various processing and management options within the exemplary IIMP 600. In this example, information from a connected data source 120 is staged in a buffer 108 and the buffer information synchronized with unified identity information 111 in a core 112. The exemplary IIMP 600 may be performed in segments, wherein an exemplary run profile 150 allows an MA 202 to perform one or more of the segments. In the flow diagram, the operations are summarized in individual blocks. The operations may be performed in hardware and/or as machine-readable instructions (software or firmware) that can be executed by a processor or engine, such as the exemplary IIMP engine 400.

At block 120, a connected information source 120 contains information to be managed by the exemplary IIMP 600.

At block 602, a step of an exemplary run profile 150 may be executed to generate a log file, e.g., an audit drop file. If the log file is to be created, the exemplary IIMP 600 branches to block 604, if not, the exemplary IIMP 600 branches to block 606.

At block 604, if the log file is to be created, a step of an exemplary run profile 150 may be executed to stop execution of the exemplary IIMP 600 after creating the log file. If the exemplary IIMP 600 is to be stopped after creating the log file, the exemplary IIMP 600 branches to block 608 to stop, otherwise the exemplary IIMP 600 branches to block 606.

At block, 606a step of an exemplary run profile 150 may be executed to stage information from the connected information source 120 in the buffer 108. If the exemplary IIMP 600 was stopped at block 608 after generating the log file, then at block 610, a step of an exemplary run profile 150 may be executed to resume the exemplary IIMP 600 at the process of staging the information in the buffer 108 (block 606).

At block 612, a step of an exemplary run profile 150 may also be executed to stop execution of the exemplary IIMP 600 after staging the information in the buffer 108. If a run profile step for stopping the execution is present, then the exemplary IIMP 600 branches to block 614 to stop, otherwise the exemplary IIMP 600 branches to block 616.

At block 616, a step of an exemplary run profile 150 may be executed to synchronize the staged information in the buffer 108 with unified identity information 111 in the core 112 and/or with other connector objects.

At block 618, a step of an exemplary run profile 150 may be executed to perform synchronizing only.

Hence, the steps of an exemplary run profile 150 not only automate many segments of an exemplary IIMP 600 so that an MA 202 does not have to be reconfigured for each segment, but also adds flexibility to the automation, since various parts of the exemplary IIMP 600 may be linked together in different ways, or the exemplary IIMP 600 may be stopped and resumed at different points in an exemplary IIMP 600.

Exemplary MIIS Run Profile

The following XML code listing of an exemplary MIIS run profile 150 includes actual values in some of the step-type elements and other elements described above. This exemplary XML run profile 150 causes an MA 202 for a MICROSOFT® ACTIVE DIRECTORY (“active directory management agent” or “ADMA”) to perform a delta import from a connected MICROSOFT® ACTIVE DIRECTORY type directory on the second step. Description of some XML elements in the listing follows the listing (line numbers added):

```
<run-configuration>
  <id>{4B4D73E7-E40B-43D5-B7E7-95C4C1CBED24}</id>
  <name>export</name>
  <creation-time>2003-05-08 19:37:11.070</creation-time>
  <version>1</version>
  <last-modification-time>2003-05-08 19:37:11.070
  </last-modification-time>
  <configuration>
    <step>
        <step-type type=“export”></step-type>
        <threshold></threshold>
        <partition>{EAC0836E-2D32-48BE-8C4C-6F26AA5F3039}
        </partition>
        <custom-data>
            <adma-step-data>
                <batch-size>100</batch-size>
                <page-size>500</page-size>
                <time-limit>30</time-limit>
            </adma-step-data>
        </custom-data>
    </step>
    <step>
        <step-type type=“delta-import”>
            <import-subtype>to-buffer</import-subtype>
        </step-type>
        <threshold></threshold>
        <partition>{EAC0836E-2D32-48BE-8C4C-6F26AA5F3039}
        </partition>
        <custom-data>
            <adma-step-data>
                <batch-size>100</batch-size>
                <page-size>500</page-size>
                <time-limit>30</time-limit>
            </adma-step-data>
    </custom-data>
    </step>
  </configuration>
</run-configuration>
```

The exemplary run profile 150 performs an export (i.e., from buffer 108 to connected information source 120) in a first step and then performs a delta import (for example, information changes in the connected information source 120 since a previous import or since a last modification, e.g., the foregoing export) in a second step.

An identifier (line 002) allows a system to keep track of this run profile 150. In the first step (lines 008-019), the step type name “export” resides as content of the element at line 009. Since the step is an export, an engine, such as the exemplary 11 MP engine 400 initializes a buffer services component 408 for reading and a logic module 414 specific to the ACTIVE DIRECTORY type directory for writing. A partition identifier (line 011) tells an MA controller 402 or an MA 202 (in this case an ADMA) which partition of a multi-partition ACTIVE DIRECTORY type directory to operate in.

Elements such as threshold (“no value”) (line 010), partition (line 011), and custom data (lines 012-018) are used in this export step to further specify the action of an MA 202, in this case the ADMA. The custom data elements (lines 012-018) pass on parameters such as batch size, page size, time limit, etc.

In the second step, the exemplary run profile 150 performs a delta import, labeled as such in the step type element (line 021). The step subtype (line 022) is “to buffer,” indicating in one implementation that the ADMA will stage information objects to the buffer 108 and stop. The rest of the elements in the second step match the elements in the first step, since the delta import is a complimentary process to the export process of the first step. Hence, the threshold (“no value”) (line 024), the partition (line 025), and the custom data (lines 026-032) are the same as for the first step.

The internal step structure of an exemplary run profile 150, that is, the type and the sequential order of the various steps used, may depend on characteristics of the MA 202 and of course, the connected information source 120 being processed. If an MA 202 manages only one data partition (e.g., as happens when managing MICROSOFT® NOTES files, SUN MICROSYSTEMS® IPLANET directory server information, or MICROSOFT® WINDOWS® NT4 server information, etc.) then a “one-partition” MA 202 may typically use an exemplary run profile 150 that has an internal step structure consisting of only one step that is either a full or delta import step, an export step, or an apply-rules step. A one-partition MA 202 may also typically use an exemplary run profile 150 that includes two steps: either a full or delta import step, and an export step.

If the MA 202 manages multiple data partitions (e.g., an MA that manages MICROSOFT® ACTIVE DIRECTORY directory information, or XML server information, etc.) then there are several exemplary step sequences that may commonly be used.

In a first exemplary step sequence, an exemplary run profile 150 for the multi-partition MA 202 may include “n” groups of steps for “n” partitions, each of the “n” groups having one step for each partition in which the step is typically a full or delta import, an export, or an apply-rules step.

In a second exemplary step sequence, an exemplary run profile 150 for the multi-partition MA 202 may include “n” groups of steps for “n” partitions, each of the “n” groups having two steps for each partition in which the steps are typically a full or delta import and an export.

In a third exemplary step sequence, an exemplary run profile 150 for the multiple-partition MA 202 may include “n” groups of steps for “n” partitions, and each of the “n” groups may have either one or two steps. If a partition has one step, the step is usually a full or delta import, an export, or an apply-rules step; and if a partition has two steps, the steps are usually a full or delta import and an export.

Of course, other exemplary step sequences using other types of steps besides those used in the examples above are possible for one-partition and multi-partition MAs. Exemplary run profiles 150, 152 could also be concatenated for execution of a longer process. For instance, audit file creation can be added via relevant run profile steps to any of the example run profiles described.

An exemplary debugging run profile 150 may also be configured, usually consisting of creating a drop file and stopping, staging to the buffer 108 and stopping, and/or resuming from file.

Exemplary Computing Device

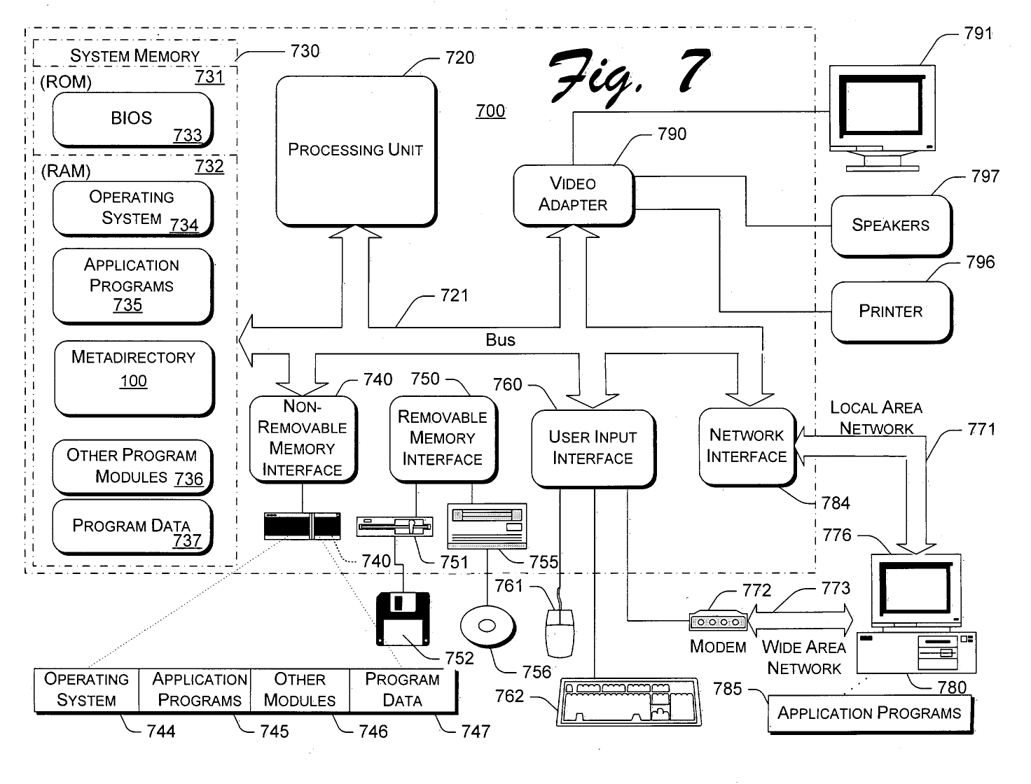

FIG. 7 shows an exemplary computer 700 suitable as an environment for practicing aspects of the subject matter. The components of exemplary computer 700 may include, but are not limited to, a processing unit 720, a system memory 730, and a system bus 721 that couples various system components including the system memory 730 to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISAA) bus, Video Electronics Standards Association (VESA) local bus, and Peripheral Component Interconnect (PCI) bus also known as the Mezzanine bus.

Exemplary computer 700 typically includes a variety of computer-readable media. Computer-readable media can be any available media that can be accessed by exemplary computer 700 and includes both volatile and nonvolatile media, removable and non-removable media. By way of example, and not limitation, computer-readable media may comprise computer storage media and communication media. Computer storage media include volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by exemplary computer 700. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection and wireless media such as acoustic, RF, infrared and other wireless media. Combinations of any of the above should also be included within the scope of computer readable media.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within exemplary computer 700, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, the exemplary metadirectory 100, application programs 735, other program modules 736, and program data 737. Although the exemplary metadirectory 100 is depicted as software in random access memory 732, other implementations of an exemplary metadirectory 100 can be hardware or combinations of software and hardware.

The exemplary computer 700 may also include other removable/non-removable, volatile/nonvolatile computer storage media. By way of example only, FIG. 7 illustrates a hard disk drive 741 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface such as interface 750.

The drives and their associated computer storage media discussed above and illustrated in FIG. 7 provide storage of computer-readable instructions, data structures, program modules, and other data for exemplary computer 700. In FIG. 7, for example, hard disk drive 741 is illustrated as storing operating system 744, application programs 745, other program modules 746, and program data 747. Note that these components can either be the same as or different from operating system 734, application programs 735, other program modules 736, and program data 737. Operating system 744, application programs 745, other program modules 746, and program data 747 are given different numbers here to illustrate that, at a minimum, they are different copies. A user may enter commands and information into the exemplary computer 700 through input devices such as a keyboard 762 and pointing device 761, commonly referred to as a mouse, trackball, or touch pad. Other input devices (not shown) may include a microphone, joystick, game pad, satellite dish, scanner, or the like. These and other input devices are often connected to the processing unit 720 through a user input interface 760 that is coupled to the system bus, but may be connected by other interface and bus structures, such as a parallel port, game port, or a universal serial bus (USB). A monitor 791 or other type of display device is also connected to the system bus 721 via an interface, such as a video interface 790. In addition to the monitor 791, computers may also include other peripheral output devices such as speakers 797 and printer 796, which may be connected through an output peripheral interface 795.

The exemplary computer 700 may operate in a networked environment using logical connections to one or more remote computers, such as a remote computer 780. The remote computer 780 may be a personal computer, a server, a router, a network PC, a peer device or other common network node, and typically includes many or all of the elements described above relative to exemplary computer 700, although only a memory storage device 781 has been illustrated in FIG. 7. The logical connections depicted in FIG. 7 include a local area network (LAN) 771 and a wide area network (WAN) 773, but may also include other networks. Such networking environments are commonplace in offices, enterprise-wide computer networks, intranets, and the Internet.

When used in a LAN networking environment, the exemplary computer 700 is connected to the LAN 771 through a network interface or adapter 770. When used in a WAN networking environment, the exemplary computer 700 typically includes a modem 772 or other means for establishing communications over the WAN 773, such as the Internet. The modem 772, which may be internal or external, may be connected to the system bus 721 via the user input interface 760, or other appropriate mechanism. In a networked environment, program modules depicted relative to the exemplary computer 700, or portions thereof, may be stored in the remote memory storage device. By way of example, and not limitation, FIG. 7 illustrates remote application programs 785 as residing on memory device 781. It will be appreciated that the network connections shown are exemplary and other means of establishing a communications link between the computers may be used.

### CONCLUSION

The foregoing describes automation of information management through a user-controllable series of runs. In one implementation the series of runs may be gathered into a run profile that has arranged steps for an agent to execute the information management process. The user-controllable series of runs, or run profile, allows performance of many information management processes by the same agent without reconfiguring the agent. The subject matter described above can be implemented in hardware, in software, or in both hardware and software. In certain implementations, the exemplary run profiles, identity information management processes, engines, and related methods may be described in the general context of computer-executable instructions, such as program modules, being executed by a computer. Generally, program modules include routines, programs, objects, components, data structures, etc. that perform particular tasks or implement particular abstract data types. The subject matter can also be practiced in distributed communications environments where tasks are performed over wireless communication by remote processing devices that are linked through a communications network. In a wireless network, program modules may be located in both local and remote communications device storage media including memory storage devices.

1. A method, comprising:
arranging instructions for an agent to execute an information management process in a metadirectory, wherein the instructions are arranged into a profile separate from the agent; and
executing the information management process according to the profile.

2. The method as recited in claim 1, further comprising arranging instructions into the profile to execute multiple information management processes.

3. The method as recited in claim 1, wherein the instructions further comprise steps, each step corresponding to a segment of an information management process.

4. The method as recited in claim 3, wherein the steps are rearrangeable into different sequences of steps corresponding to different information management processes.

5. The method as recited in claim 1, further comprising establishing the agent to execute the information management process between the metadirectory and an information source.

6. The method as recited in claim 5, further comprising providing the profile to the agent to execute the information management process.

7. The method as recited in claim 6, wherein the profile is provided as a parameter of an execute function of the agent.

8. The method as recited in claim 6, wherein the profile is stored as part of a configuration file of the agent.

9. The method as recited in claim 1, wherein the information management process is an information transfer from an information source to the metadirectory.

10. The method as recited in claim 9, wherein the information management process is an information transfer from an information source to a buffer of the metadirectory.

11. The method as recited in claim 1, wherein the information management process is creation of an information file.

12. The method as recited in claim 11, wherein the information management process is an information transfer from the information file to a buffer of the metadirectory.

13. The method as recited in claim 1, wherein the information management process is an information transfer to a core of the metadirectory.

14. The method as recited in claim 1, wherein the information management process is creation of an audit trail for auditing execution of information transfers.

15. The method as recited in claim 14, further comprising creating a profile from the audit trail.

16. The method as recited in claim 1, wherein the information management process is an information transfer from a buffer of the metadirectory to an information source outside the metadirectory.

17. The method as recited in claim 14, further comprising creating an audit file during the information transfer.

18. The method as recited in claim 15, further comprising resuming an information transfer to the information source outside the metadirectory from the audit file.

19. The method as recited in claim 1, wherein the information management process is a synchronization between information in a buffer of the metadirectory and a core of the metadirectory.

20. The method as recited in claim 1, wherein the information management process is an attribute flow between information objects.

21. The method as recited in claim 1, wherein the information management process is an evaluation of attribute flow in a buffer of the metadirectory.

22. The method as recited in claim 1, wherein the information management process is an evaluation of attribute flow in a buffer of the metadirectory associated with the agent.

23. The method as recited in claim 1, wherein the profile is stored as metadata for a configuration file of the agent on a computing device.

24. The method as recited in claim 1, wherein the profile is expressed in an extensible markup language.

25. The method as recited in claim 24, wherein the extensible markup language is a version of XML.

26. The method as recited in claim 1, further comprising instructions to stop an information management process after its completion.

27. An information system, comprising:
a rules layer for defining the information system;
a storage layer having a buffer and a core defined by rules in the rules layer, wherein the buffet includes information from at least one of multiple information sources and wherein the core holds core information from the buffer;
a services layer having agents defined by the rules for performing information management processes; and
a profile in the rules layer for controlling execution of an agent.

28. The information system as recited in claim 27, wherein the profile is stored separately from the agent.

29. The information system as recited in claim 27, wherein the profile is stored separately from a configuration file of the agent.

30. The information system as recited in claim 29, wherein the profile controls the agent without reconfiguration of the agent.

31. The information system as recited in claim 29, wherein the profile controls the agent to execute multiple information management processes without reconfiguration of the agent.

32. The information system as recited in claim 27, further comprising an auditor for creating an audit trail of the execution of an agent, wherein a rule creates a profile from the audit trail.

33. The information system as recited in claim 27, wherein the auditor creates an audit trail comprising executable code.

34. The information system as recited in claim 33, wherein a profile is created from at least part of the executable code.

35. The information system as recited in claim 27, further comprising an auditor for creating an audit trail of information management processes, wherein a rule may create a profile from the audit trail.

36. An information management engine, comprising:
an agent controller, wherein an agent performs at least part of an information management process in a metadirectory system having a rules layer, a storage layer having a buffer and a core, the buffer storing information from at least one of multiple information sources and the core storing information from the buffer, and a services layer having agents for performing information management processes; and
a run profile producer, wherein a run profile controls execution of an agent.

37. The information management engine as recited in claim 36, further comprising execution step instructions, wherein the profile is made of execution steps arranged in a sequence from the execution step instructions.

38. The information management engine as recited in claim 36, further comprising an execution auditor to create an audit trail of execution steps performed in the metadirectory.

39. The information management engine as recited in claim 38, wherein the run profile producer uses the audit trail to produce a profile.

40. The information management engine as recited in claim 37, wherein an execution step comprises transferring information from an information source to the buffer and from the buffer to the core.

41. The information management engine as recited in claim 37, wherein an execution step comprises creating a drop file.

42. The information management engine as recited in claim 37, wherein an execution step comprises creating an audit file or an audit trail.

43. The information management engine as recited in claim 37, wherein an execution step comprises stopping an information management process.

44. The information management engine as recited in claim 43, wherein an execution step comprises resuming the information management process using a drop file.

45. The information management engine as recited in claim 37, wherein an execution step comprises transferring information from an information source to the buffer and stopping before beginning another execution step.

46. The information management engine as recited in claim 37, wherein an execution step comprises transferring information from an information source to the buffer and from the buffer to the core.

47. The information management engine as recited in claim 37, wherein an execution step comprises transferring information from the buffer to an information source outside the metadirectory.

48. The information management engine as recited in claim 37, wherein an execution step comprises transferring information from an information source to the buffer and from the buffer to the core.

49. The information management engine as recited in claim 37, wherein an execution step comprises attempting to synchronize information in the core with information in the buffer.

50. The information management engine as recited in claim 37, wherein an execution step comprises attempting to evaluate information attribute flow for information in the buffer.

51. The information management engine as recited in claim 50, wherein an execution step comprises attempting to evaluate information attribute flow for information in the buffer relative to an agent associated with the execution step.

52. A data structure, comprising:
a run profile for a metadirectory management agent.

53. The data structure as recited in claim 52, further comprising a sequence of step elements in the run profile for executing the agent, wherein the agent controls at least one information transfer in the metadirectory.

54. The data structure as recited in claim 53, wherein the step elements describe segments of an overall information management process of the metadirectory.

55. The data structure as recited in claim 53, wherein the step elements can be rearranged to execute various parts of the information management process of the metadirectory.

56. The data structure as recited in claim 53, wherein the run profile is metadata for the management agent.

57. The data structure as recited in claim 56, wherein the metadata is stored separately from configuration data of the management agent.

58. The data structure as recited in claim 54, further comprising a sequence of step elements for a management agent that performs an information management process associated with an information source having one data partition.

59. The data structure as recited in claim 54, further comprising a sequence of step elements for a management agent that performs an information management process associated with an information source having multiple data partitions.

60. The data structure as recited in claim 59, further comprising “n” groups of steps “n” for “n” partitions, each group having one step for each partition, wherein the one step is one of an information import from an information source into the metadirectory, an information export from the metadirectory, or an application of a metadirectory rule.

61. The data structure as recited in claim 59, further comprising “n” groups of steps “n” for “n” partitions, each group having two steps comprising an information import into the metadirectory and an information export from the metadirectory.

62. The data structure as recited in claim 59, further comprising “n” groups of steps “n” for “n” partitions, each group having either one step or two steps, wherein if a group has one step the one step is one of an information import from an information source into the metadirectory, an information export from the metadirectory, or an application of a metadirectory rule, and if a group has two steps the two steps are an information import into the metadirectory and an information export from the metadirectory.

63. The data structure as recited in claim 52, wherein at least some elements of the data structure are obtained from an executable code produced as a runtime record of an information process in the metadirectory.

64. An executable instruction, comprising:
logic for controlling at least part of an execution of a management agent in a metadirectory system, wherein the management agent performs at least part of an information management process; and
logic for connecting in a rearrangeable logic pattern with other executable instructions having logic for controlling at least part of an execution of a management agent.

65. The executable instruction as recited in claim 64, wherein the logic of the executable instruction controls the management agent to perform different types of information management processes without reconfiguration of the management agent.

66. A management agent for a metadirectory system, comprising:
a means for establishing a data communications connection between an information source and a metadirectory;
a means for obtaining processing logic from one or more rules for performing one or more information management processes;
an execution function to read, a run profile having execution logic for executing the processing logic.

67. The management agent as recited in claim 66, wherein the management agent is capable of performing multiple information management processes in a sequence without changing a configuration of the management agent, including without changing a configuration of the means for establishing a data communications connection and without changing a configuration of the processing logic.

68. One or more computer readable media containing instructions that are executable by a computer to perform actions, comprising:
arranging execution steps for an agent to execute an information transfer in a directory, wherein the execution steps are arranged into a profile separate from the agent; and
executing the information transfer according to the profile.

69. The one or more computer readable media as recited in claim 68, further comprising instructions for arranging the execution steps into the profile to execute multiple information transfers in a sequence.

70. The one or more computer readable media as recited in claim 68, wherein each execution step corresponds to a segment of an overall information management process of the directory.

71. The one or more computer readable media as recited in claim 70, wherein the execution steps are rearrangeable into different sequences corresponding to performing segments of the overall information management process in different sequences.

72. The one or more computer readable media as recited in claim 68, wherein the profile is usable with different agents.

73. A method, comprising:
configuring a set of instructions for executing each mode of an information management process to be performed between at least two information sources, wherein the information management process has multiple modes; and
storing each set of instructions, wherein each set of instructions can be unstored and executed as a step to perform a mode of the information management process.

74. The method as recited in claim 73, further comprising creating a profile of steps to perform a sequence of modes of the information management process.

75. The method as recited in claim 74, further comprising rearranging the steps to create different profiles.

76. The method as recited in claim 75, further comprising selecting a profile to execute a sequence of modes of the information management process.

77. The method as recited in claim 73, wherein each set of instructions executes a mode selected from a group modes, consisting of a full synchronizing mode, a partial synchronizing mode, an importing mode, an exporting mode, a buffering mode, a staging mode, an auditing mode, a data aggregating mode, an accounts managing mode, an attributes importing mode, an attributes exporting mode, a joining mode, a projecting mode, a data transforming mode, a provisioning mode, and a deprovisioning mode.

78. The method as recited in claim 73, wherein one of the at least two information sources is a database.

79. The method as recited in claim 73, wherein one of the at least two information sources is a table in a multitable database.

80. The method as recited in claim 73, wherein one of the at least two information sources is a directory.

81. The method as recited in claim 73, wherein one of the at least two information sources is a file.

82. The method as recited in claim 73, wherein one of the at least two information sources is an account.

83. The method as recited in claim 73, wherein a set of instructions includes connectivity information for communicating with a particular information source.

84. The method as recited in claim 73, wherein a set of instructions includes threshold information for qualifying a mode of the information management process.

85. The method as recited in claim 73, wherein a set of instructions includes partition information for specifying a data partition of an information source having multiple partitions.
